(19) United States
(12) Patent Application Publication
(10) Pub. No.: US 2024/0362012 A1
(43) Pub. Date: Oct. 31, 2024

(54) CONFIGURABLE HELM MERGE UTILITY

(71) Applicant: OPEN TEXT HOLDINGS, INC., Menlo Park, CA (US)

(72) Inventors: Shreenidhi Ramarao, Bangalore (IN); Bhargavi Yeramanedi, Bangalore (IN)

(21) Appl. No.: 18/649,480

(22) Filed: Apr. 29, 2024

Related U.S. Application Data
(60) Provisional application No. 63/615,061, filed on Dec. 27, 2023.

(30) Foreign Application Priority Data
Apr. 27, 2023 (IN) 202341030283

(51) Int. Cl. G06F 8/65

(52) U.S. Cl. CPC G06F 8/65

(57) ABSTRACT

A system and method enable the merging of a new Helm chart with a current Helm chart for ease of update/upgrade deployment. A Helm merge utility merges the new Helm chart with old Helm chart values automatically, while removing disabled components. The Helm merge utility enables users to save valuable time and resources during cloud upgrades, while increasing reliability.

### CROSS-REFERENCE TO RELATED APPLICATIONS

This application claims a benefit of priority under 35 U.S.C. § 119 (e) from U.S. Provisional Application No. 63/615,061, filed Dec. 27, 2023, entitled “CONFIGURABLE HELM MERGE UTILITY,” and Indian patent application No. 202341030283, filed Apr. 27, 2023, entitled “CONFIGURABLE HELM MERGE UTILITY,” the contents of which are fully incorporated by reference herein for all purposes.

### TECHNICAL FIELD

This disclosure relates generally to container orchestration. In particular, this disclosure relates to systems and methods for providing configurable Helm merge utilities for faster deployment and ease of deployment of updates or upgrades.

### BACKGROUND

Helm is a package manager for Kubernetes (an open-source container orchestration platform that automates the deployment, scaling, and management of containerized applications) that simplifies the deployment and management of applications. Helm helps users define and package resources, such as deployments, services, configurations, etc., into a versioned artifact called a Helm chart, as one skilled in the art would understand.

Traditionally, to upgrade a cloud deployment via Helm to a newer version of the product, the old master Helm chart values are manually updated in a new master Helm chart. A Helm chart may contain thousands of lines of code to update, which is error prone, time consuming, and not reliable.

In view of the foregoing, there is room for innovations and improvements for providing faster deployment and ease of deployment of updates or upgrades.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### SUMMARY

In some embodiments, containerization systems and methods are described that, responsive to a request to update a cloud-based container having an existing master Helm chart, provides an updated master Helm chart containing settings, names, and comments. For one or more components of the cloud-based container that have been disabled by a user, settings in the updated master Helm chart associated with the disabled components can be removed. A Helm merge utility is executed to automatically merge the updated master Helm chart with the existing master Helm chart. This merging can include migrating the settings, names, and comments from the new master Helm chart to the existing master Helm chart.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a sequence diagram illustrating one way of performing cloud deployment.

FIG. 2 is a flowchart showing an embodiment of the Helm merge utility functionality.

FIG. 3 is a sequence diagram illustrating another way of performing cloud deployment using a helm merge utility.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

For the purposes of this description, it may be helpful to understand the operation of a containerization framework for deploying containers in a container orchestration cloud environment. Commonly-owned U.S. patent application Ser. No. 18/151,271, entitled “CUSTOMIZABLE CONTAINERIZATION FRAMEWORK SYSTEM AND METHOD,” filed on Jan. 6, 2023 and Ser. No. 18/151,273, entitled “CUSTOMIZABLE CONTAINERIZATION FRAMEWORK SYSTEM AND METHOD,” filed on Jan. 6, 2023, each describe embodiments of customizable containerization frameworks, and are incorporated herein by reference in their entireties for all purposes.

The novel Helm merge utility disclosed below allows users to merge a new Helm chart with a current Helm chart. The disclosed Helm merge utility merges the new Helm chart with old Helm chart values automatically, including settings, names, comments, etc. For the components/sub charts that are disabled, the respective component section is removed by the utility from the YAML file, which gives better ease of Helm chart readability. In some embodiments, the components that are disabled are moved to a different YAML file for future reference and requirements. In some embodiments, a master Helm chart can be used with the deployment of multiple products (or group of products) via the same master Helm chart.

Generally, as mentioned above, the present disclosure describes a system and method for merging a new Helm chart with a current Helm chart for ease of update/upgrade deployment. Such updates/upgrades may result from new product updates, security vulnerability fixes/patches, etc., as one skilled in the art would understand. The disclosed Helm merge utility merges the new Helm chart with old Helm chart values automatically, while removing disabled components. The disclosed techniques may be applied to other types of container orchestration environments as well. Following are several advantages of the disclosed solution:
The Helm merge utility helps users save more than 90% of their time during cloud upgrade readiness with Helm charts.
The Helm merge utility is more reliable, since there is no manual intervention required.
The Helm merge utility is configurable and dynamic in terms of final chart generation based on enabled/disabled components, which means the final chart has only enabled components and the disabled components are moved to another file for future references/updates.
The Helm merge utility updates only the old values in the new charts and retains new sections/addition of new chart.

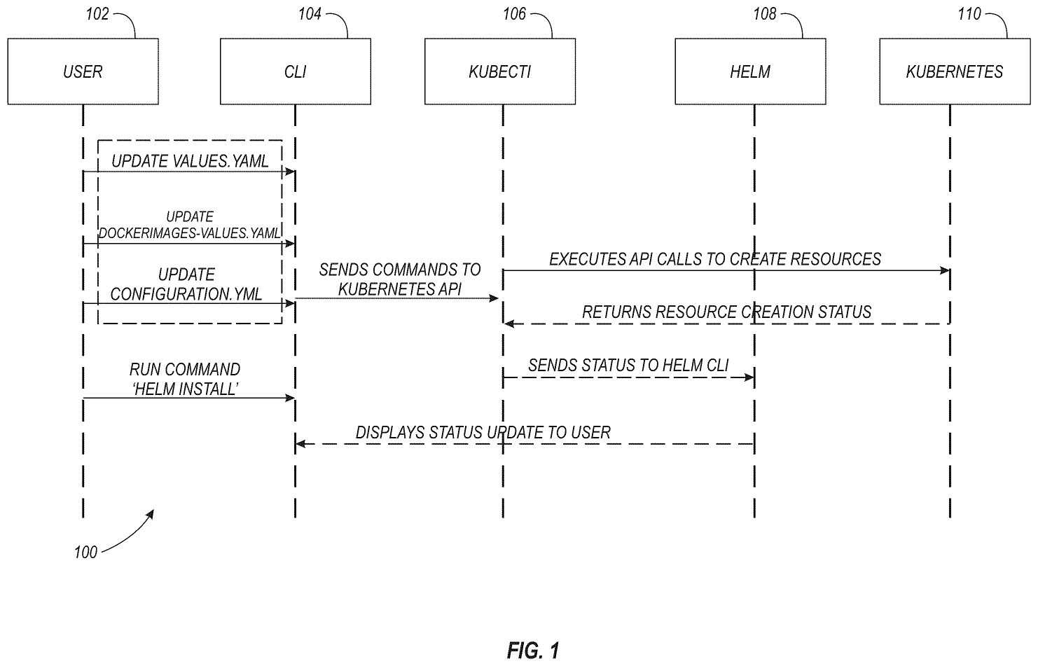

It may be helpful to understand examples of traditional ways of cloud deployment. Following is an example of one way of performing cloud deployment. FIG. 1 is a sequence diagram 100 illustrating one way of performing cloud deployment. In the example shown in FIG. 1, each required YAML file in the new Helm chart must be manually updated by a user 102 with the old Helm chart values which is time consuming and highly error prone. As shown in the dashed box in the example of FIG. 1, the manual updates include updating the YAML files ‘values.yaml’, ‘dockerimages-values.yaml’, and ‘configuration.yml’. Other manual updates may also be needed, as one skilled in the art would understand. The updated YAML files are provided to a command line interface (CLI) 104, which sends commands to the Kubernetes API. A run command (“helm install”) is also provided to the CLI 104. Kubecti 106 (a command-line interface for interacting with a Kubernetes cluster), receives the commands and executes an API call to Kubernetes 110 to create resources. Kubernetes 110 returns a resource creation status to Kubecti 106. Kubecti 106 then sends a status to the Helm CLI 108, which then returns a status update to the user, via the CLI 104. In the example timing diagram shown in FIG. 1, the operations shown in the dashed box between the user 102 and the CLI 104 are the manual updates that are performed by the user.

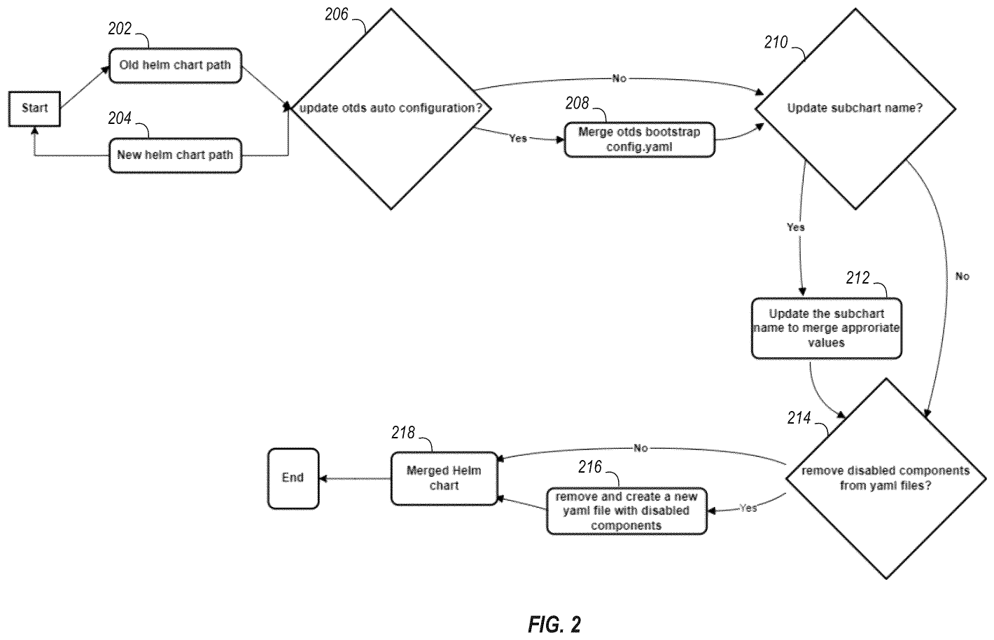

To overcome the time-consuming and error-prone process described above, the novel Helm merge utility is used where the required YAML files in the Helm chart are updated with the old deployment values. FIG. 2 is a flowchart showing an embodiment of the Helm merge utility functionality.

As shown in FIG. 2, an old Helm chart path 202 and a new Helm chart path 204 are shown. At step 206, the process asks if the directory service (e.g., the OTDS-OpenText Directory Services) auto configuration should be updated. If not, the process proceeds to the step 210 (discussed below). If yes, at step 208, the process merges the OTDS bootstrap ‘config.yaml’ file. Next, at step 210, the process asks if the subchart name should be updated. If not, the process proceeds to step 214 (discussed below). If yes, at step 212, the subchart name is updated to merge the appropriate values. Next, at step 214, the process asks if disabled components from the YAML files should be removed. If not, the process proceeds to step 218 (discussed below). If yes, at step 216, the disabled components are removed and a new YAML file is created with the disabled components for future reference. At step 218, the merged Helm chart is complete.

Following are exemplary user inputs that can be passed while running the described Helm merge utility, as described above with respect to FIG. 2. Other examples are also possible, as one skilled in the art would understand.
The old/deployed Helm chart path.
The new Helm chart to be updated.
If the OTDS bootstrap config YAML is used (Yes/No?). If yes, then update the bootstrap config YAML in the new chart, else skip.
If old sub chart(s) name(s) is updated in the new Helm chart (Yes/No?). If yes, then pass the oldSubchartName: updatedSubchartName and update the sub chart name before merging the values, else skip.
Want to remove disabled components from the YAML file (Yes/No?). If yes, then remove the disabled components from the YAML files and create a new YAML file with all the disabled components for future requirement/reference, else skip.

Once all the user inputs are provided, the new Helm chart is now overwritten and merged with older values.

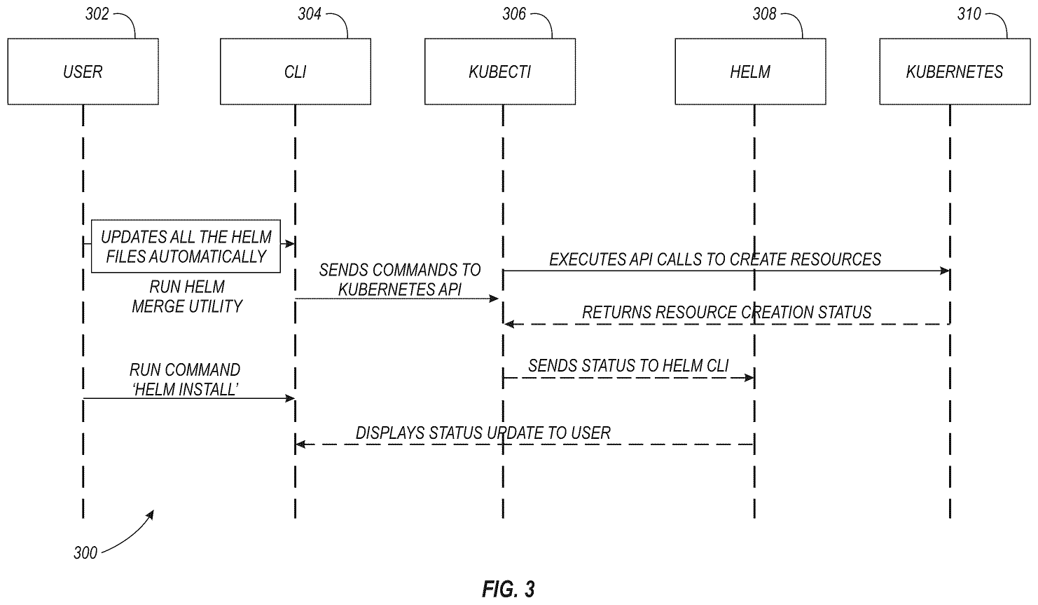

FIG. 3 is a sequence diagram that depicts the number of manual steps replaced by using merge utility (as compared the example shown in FIG. 1), which saves around 90% of the time that goes in updating the Helm chart values.

Similar to FIG. 1, FIG. 3 is a sequence diagram illustrating one way of performing cloud deployment, but with the help of the disclosed Helm merge utility. In the example shown in FIG. 3, the Helm merge utility is run to update all of the Helm files automatically. As before, the updated YAML files are provided to a command line interface (CLI) 304, which sends commands to the Kubernetes API. A run command (“helm install”) is also provided by user 302 to the CLI 304. Kubecti 306 (a command-line interface for interacting with a Kubernetes cluster), receives the commands and executes an API call to Kubernetes 310 to create resources. Kubernetes 310 returns a resource creation status to Kubecti 306. Kubecti 306 then sends a status to the Helm CLI. Helm 308 then returns a status update to the user, via the CLI 304.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally, then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of containerization, comprising:
responsive to a request to update a cloud-based container having an existing master Helm chart, providing an updated master Helm chart containing settings, names, and comments;
for one or more components of the cloud-based container that have been disabled by a user, removing settings in the updated master Helm chart associated with the disabled components;
executing a Helm merge utility, the Helm merge utility automatically merging the updated master Helm chart with the existing master Helm chart, the merging including migrating the settings, names, and comments from the new master Helm chart to the existing master Helm chart; and
deploying the merged master Helm chart.

2. The method of claim 1, wherein for the one or more components of the cloud-based container that have been disabled, removing respective component sections from a YAML file associated with the updated master Helm chart.

3. The method of claim 1, wherein the removed respective component sections are moved to another YAML file for future reference.

4. The method of claim 2, further comprising prompting a user whether or not to remove disabled components from the YAML file.

5. The method of claim 1, wherein the merged master Helm chart includes new values from the updated master Helm chart and values from the existing master Helm chart.

6. The method of claim 1, wherein the Helm merge utility determines if an existing sub chart name has been updated and updates the sub chart name before merging the updated master Helm chart with the existing master Helm chart.

7. The method of claim 1, wherein the updated master Helm chart relates to a product upgrade.

8. The method of claim 1, wherein the updated master Helm chart relates to security vulnerability fix.

9. A system for containerization, comprising:
a processor;
a non-transitory computer-readable medium; and
stored instructions translatable by the processor for executing:
responsive to a request to update a cloud-based container having an existing master Helm chart, providing an updated master Helm chart containing settings, names, and comments;
for one or more components of the cloud-based container that have been disabled by a user, removing settings in the updated master Helm chart associated with the disabled components;
executing a Helm merge utility, the Helm merge utility automatically merging the updated master Helm chart with the existing master Helm chart, the merging including migrating the settings, names, and comments from the new master Helm chart to the existing master Helm chart; and
deploying the merged master Helm chart.

10. The system of claim 8, wherein for the one or more components of the cloud-based container that have been disabled, removing respective component sections from a YAML file associated with the updated master Helm chart.

11. The system of claim 10, wherein the removed respective component sections are moved to another YAML file for future reference.

12. The system of claim 10, further comprising prompting a user whether or not to remove disabled components from the YAML file.

13. The system of claim 9, wherein the merged master Helm chart includes new values from the updated master Helm chart and values from the existing master Helm chart.

14. The system of claim 9, wherein the Helm merge utility determines if an existing sub chart name has been updated and updates the sub chart name before merging the updated master Helm chart with the existing master Helm chart.

15. The system of claim 9, wherein the updated master Helm chart relates to a product upgrade.

16. The system of claim 9, wherein the updated master Helm chart relates to security vulnerability fix.

17. A computer programming product comprising a non-transitory computer-readable medium storing instructions for containerization, the instructions translatable by a processor for:
responsive to a request to update a cloud-based container having an existing master Helm chart, providing an updated master Helm chart containing settings, names, and comments;
for one or more components of the cloud-based container that have been disabled by a user, removing settings in the updated master Helm chart associated with the disabled components;
executing a Helm merge utility, the Helm merge utility automatically merging the updated master Helm chart with the existing master Helm chart, the merging including migrating the settings, names, and comments from the new master Helm chart to the existing master Helm chart; and
deploying the merged master Helm chart.

18. The computer programming product of claim 17, wherein for the one or more components of the cloud-based container that have been disabled, removing respective component sections from a YAML file associated with the updated master Helm chart.

19. The computer programming product of claim 18, wherein the removed respective component sections are moved to another YAML file for future reference.

20. The computer programming product of claim 18, wherein the merged master Helm chart includes new values from the updated master Helm chart and values from the existing master Helm chart.
